(19) United States
(12) Patent Application Publication
(10) Pub. No.: US 2017/0073142 A1
(43) Pub. Date: Mar. 16, 2017

(54) REPAIR KIT FOR PREPARING POLYMERIC COMPOSITIONS FOR REPAIRING SURFACES AND METHODS OF USE THEREOF

(71) Applicants: Robert M. Loomis, Aliso Viejo, CA (US); Michael R. Wetherell, Eugene, OR (US); Nathan E. Werst, Eugene, OR (US); Mark T. Anater, Eugene, OR (US)

(72) Inventors: Robert M. Loomis, Aliso Viejo, CA (US); Michael R. Wetherell, Eugene, OR (US); Nathan E. Werst, Eugene, OR (US); Mark T. Anater, Eugene, OR (US)

(21) Appl. No.: 14/854,668

(22) Filed: Sep. 15, 2015

(51) Int. Cl. B65D 81/32; C08G 18/32; C08G 18/76; B65D 25/08; C08G 18/08

(52) U.S. Cl. CPC B65D 81/32; B65D 25/08; C08G 18/0838; C08G 18/7657; C08G 18/3203

(57) ABSTRACT

A repair kit for use in preparing a polymeric composite material and methods for preparing the polymer composite material are described. The repair kit includes a sealed container and a first removable divider arranged transversely across the sealed container. The divider is configured to engage the sealed container to form a first compartment and a second compartment. The first compartment and the second compartment are isolated from one another when the first removable divider is engaged with the sealed container. The first compartment contains a resin component and the second compartment contains a reactive component. The sealed container is configured such that removal of the first removable divider enables mixing of the resin component and the reactive component within the sealed container. The repair kit may also include a second removable divider to form a third compartment. The repair kit may also include a catalyst and a filler. The polymeric composite material can be used in repairing damaged surfaces, including pavements, roadways, facilities, structures, and railway infrastructure.

### FIELD OF THE INVENTION

The present disclosure is generally related to a repair kit and a sealed container comprising components that can be mixed to form a polymeric composition for use in repairing damaged surfaces and methods for preparing such composition for use in repairing the damaged surfaces. Exemplary surfaces include pavements, roadways, facilities, structures (e.g., bridges), and railway infrastructure.

### BACKGROUND OF THE INVENTION

Polymeric composite materials can be used to repair and restore damaged surfaces such as cracked pavement. For example, road repair crews can use polymeric composite materials to patch cracks, holes, and the like along a stretch of roadway. Polymeric composite materials generally include a mixture of a resin component, a reactive component, and a filler component. The components can be mixed together to form a polymeric composite that can be used in repairing damaged surfaces. Once the components are mixed together, the polymeric composite material remains pliable or “workable” for a relatively short time, e.g. 45 minutes, before the polymeric composite material cures and is no longer pliable. Thus, it is advantageous to use the polymeric composite material shortly after mixing of the components in order to take full advantage of the workable life of the composite material. As such, it is efficient and effective to mix the components at the site of surface repair to maximize the usable life of the polymeric composite material.

Unfortunately, conventional methods of producing polymeric composite materials onsite require the use of mixing equipment, which can be cumbersome, requires electrical power, and can result in user exposure to undesirable chemicals during mixing. One example of such mixing equipment is a drill with an attachment that is used to mix the resin, the reactive component and the filler in a container such as a bucket.

Another known method for producing polymeric composite material includes mixing the filler, the resin and the reactive component in a batch mixer for several minutes until the filler is uniformly coated with the combined resin and reactive component before it is set into place (for example, by pouring the polymeric composite material into place). The batch mixing uses bulky and expensive equipment and instrumentation to mix the components. It can be difficult to transport the bulky equipment to more remote locations for surface repairs. Additionally, because of the size of the batch mixing equipment, it can be difficult to have the equipment immediately at the site of repair, thus the polymeric composite materials typically have to be relocated quickly to the site of repair to avoid the polymeric composite material curing and hardening before the repair can be made.

Sand can be used as a filler material in polymeric composite materials. When sand is included as the filler, a mechanical apparatus can be used to mix the polymeric composite material. Polymeric composite materials comprising sand as filler may experience a phenomenon commonly referred to in the industry as “crashing out,” wherein the sand that has been mixed together with and suspended in the polymeric composite material falls out of suspension and settles to the bottom of the container holding the polymeric composite material thus making the material unsuitable for use.

The compositions and kits described herein address some of the disadvantages of conventional polymeric composite materials.

### BRIEF SUMMARY

A repair kit for use in repairing aged and/or damaged portions of a surface is described herein. In a first aspect of the invention, the repair kit includes a sealed container; and a first removable divider arranged transversely across the sealed container, with the divider being configured to engage the sealed container to form a first compartment and a second compartment. The first compartment and the second compartment are isolated from one another when the first removable divider is engaged with the sealed container. The first compartment contains a resin component and the second compartment contains a reactive component. The sealed container is configured such that removal of the first removable divider enables mixing of the resin component and the reactive component within the sealed container.

In a feature of the first aspect of invention, the repair kit further includes a second removable divider arranged transversely across the sealed container, with the divider being configured to engage the sealed container to form a third compartment. The third compartment is isolated from the first compartment and the second compartment when the second removable divider and the first removable divider are engaged with the sealed container. The third compartment contains a third component, which is different from the resin component and the reactive component. The sealed container is configured such that the contents of the first compartment, the second compartment, and the third compartment can be combined when the first removable divider and the second removable divider are disengaged, enabling mixing of the resin component, the reactive component, and the third component within the sealed container.

In another feature of the first aspect, the resin component comprises a resin. With regard to this feature, the reactive component may include an isocyanate containing compound or an epoxy hardener and the third component may include a filler. With further regard to this feature, the resin can be selected from the group consisting of an epoxy resin, a polyol resin, a polyurethane forming resin, a polyurea resin and mixtures thereof. Moreover, if the resin is a polyol resin, it may be selected from the group consisting of a polyol with a hydroxyl-terminated backbone of a member selected from the group consisting of polyether, polyester, polycarbon, polydiene, and polycaprolactone; hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols, polyalkyleneether triols, adipic acid-ethylene glycol polyester, polybutylene glycol, polypropylene glycol and hydroxyl-terminated polybutadiene. Additionally, the resin component may comprise polypropylene glycol.

In an additional feature of the first aspect, the isocyanate containing compound can be selected from the group consisting of aliphatic isocyanates, cycloaliphatic isocyanates, aryl isocyanates, aromatic cyanates, and combinations thereof. The isocyanate containing compound may be selected from the group consisting of 1,6-hexamethylene diisocyanate, 1,4-butylene diisocyanate, furfurylidene diisocyanate, 2,4-toluene diisocyanate, 2,6-toluene diisocyanate, 2,4′-diphenylethane, diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenze, 2,4-diisocyanate-s-triazine, 1-methyl-2,4-diisocyanato cyclohexane, p-phenylene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and combinations thereof.

In yet another feature, the first aspect may also include a catalyst. The catalyst may include tin, mercury, lead, bismuth, zinc or various amine compounds. The filler that is in the repair kit may be selected from the group consisting of rock, glass, rubber crumb, sand, architectural stone, polystyrene and combinations thereof. For example, the filler may include glass. More particularly, the glass may be recycled glass.

In a further feature of the first aspect the densities of the reactive component and the resin component may be substantially similar. Additionally, the density of the filler may be approximately 2 lbs./gallon greater than the densities of the reactive component and the resin component. Further, the densities of the reactive component, the resin component, and the filler may be substantially similar.

In another feature of the first aspect, the removable dividers may include a snap, clip, insert, or a combination thereof.

In a second aspect of the invention, a method for preparing a composite material for repairing a surface includes providing a repair kit comprising a sealed container having at least a resin component and a reactive component enclosed therein and a first removable divider configured to engage the sealed container to isolate the resin component from the reactive component. The method also includes disengaging the first removable divider from the sealed container, wherein disengaging the first removable divider allows the resin component to be combined with the reactive component in the sealed container and mixing the resin component and the reactive component in the sealed container to form the composite material.

In a feature of the second aspect, the method further includes providing a second removable divider for the repair kit, wherein the second removable divider is configured to engage the sealed container to form a third compartment enclosing a third component. The second removable divider and the first removable divider may be removed from the sealed container. Removing the second removable divider and the first removable divider allows the reactive component, the resin component, and the third component to be combined in the sealed container. Then the reactive component, the resin component, and the third component can be mixed in the sealed container to form the composite material. The combined components can be mixed without a mechanical apparatus.

### BRIEF DESCRIPTION OF THE DRAWINGS

Hereinafter, the invention will be explained in further detail, by way of example only, of the accompanying figures, in which:

FIG. 1 is a schematic plan view of a sealed container with a removable divider for preparing a composite for repairing a surface.

FIG. 2 is a schematic plan view of the sealed container of FIG. 1 with the removable divider removed.

FIG. 3 is a schematic plan view of a sealed container with two removable dividers for preparing a composite for repairing a surface.

FIG. 4 is a schematic plan view of the sealed container of FIG. 3 with one of the removable dividers removed.

FIG. 5 is a schematic plan view of the sealed container of FIG. 3 with both of the removable dividers removed.

### DETAILED DESCRIPTION

A repair kit for use in repairing aged and/or damaged portions of a surface (for example, pavement) and methods of using the repair kit are described herein. The repair kit comprises packaging in the form of a sealed container enclosing a resin component and a reactive component that react to form a polymeric composite material when mixed. The polymeric composite material can be used to repair aged and/or damaged portions of a surface (for example, pavement). The repair kit also comprises a first removable divider engaged with the sealed container in a manner to form and create a first compartment and a second compartment, wherein the first compartment and the second compartment are separate and isolated from one another while the first removable divider is in place. As such, the first compartment and second compartment are not in fluid communication with one another when the first removable divider is in place. The repair kit may also include a second removable divider that can form and create a third compartment, which is separate and isolated from the first and second compartments when the second removable divider is in place.

When the first removable divider is in place, the resin component may be contained within the first compartment and the reactive component may be contained within the second compartment. When the first removable divider is removed, the resin component and the reactive component can be combined, mixed, and reacted to form the polymeric composite material. Advantageously, the repair kit utilizes a single sealed container enclosing the components that are mixed and reacted to form the polymeric composite material. The components that react are separated and isolated from one another prior to combining by one or more removable dividers. Because combining and mixing of the components takes places within the sealed container, exposure thereto during the mixing process is substantially eliminated during the mixing process thus reducing the risk of potential contamination of the components prior to mixing.

The repair kit described herein provides advantages in repairing aged or damaged portions of surfaces. For example, repairing damaged surfaces with the repair kit can be performed quickly and easily onsite; the polymeric composite material does not have to be prepared and mixed at a facility nearby and then relocated quickly to the site of repair. Further, a mechanical apparatus is not required to mix the materials enclosed in the repair kit, rather the materials can be mixed by hand, thereby avoiding costly equipment and power requirements and the inconvenience of carrying a mechanical apparatus to the site of repair or running power to a remote work site.

Additionally, as will be explained in greater detail below, the components used in the repair kit, help to reduce, avoid or completely eliminate the “crashing out” effect of the components in the polymeric composite material. Density differences between the components can lead to a portion of the components settling to the bottom of the container shortly after mixing (i.e. “crashing out”), thus making the composite material unsuitable for use. Thus, exemplary embodiments of the repair kit comprise components having densities that are relatively similar to one another thereby reducing, minimizing or eliminating “crashing out” of a portion of the components.

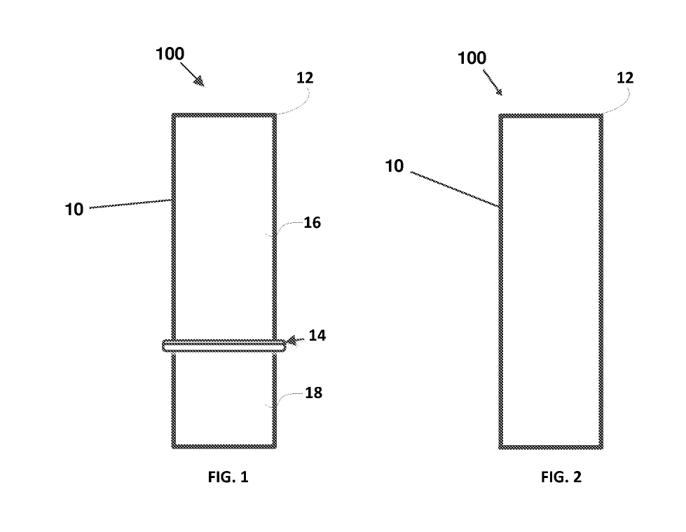

FIG. 1 shows a repair kit 100 comprising a sealed container 10 with a removable divider 14. As shown, container 10 includes an exterior surface 12. The sealed container 10 generally may be made of any flexible material suitable for use as described herein. For example, the sealed container may be constructed from Mylar®. Preferably, the sealed container 10 is made of a material that does not react with the components used to make the polymeric composite material. In manufacturing the sealed container, the exterior surface 12 may be formed by two sheets of laminated material, sealed around the edges, or may be made from a tube cut into segments of appropriate length with the ends sealed.

As can be seen in FIG. 1, the removable divider 14 is arranged transversely across the sealed container 10, and is configured to engage the sealed container 10 to form a first compartment 16 and a second compartment 18, which are separated and isolated from one another when the removable divider 16 is engaged with the sealed container 10. The removable divider crosses from one side of the sealed container 10 to the side directly opposite of it. The removable divider 14 can be a clip. Other types of package sealing such as heat sealing, snaps, clips, inserts, or combinations thereof may be used as the removable divider. The divider 14 may or may not be completely physically removable from the sealed container. Rather, the term “removable” divider includes embodiments that are not completely physically separated from the sealed container but still provide separate and isolated compartments and can be manipulated so as to eliminate the separate compartmental nature of the sealed container. One such example is a zipper locking mechanism used on commercially available storage bags.

As indicated above, the removable divider 14 forms and creates two separate compartments within the sealed container 10. As shown in FIG. 1, the sealed container 10 includes a first compartment 16 and a second compartment 18. The size of the first compartment 16 and the second compartment 18 may depend upon the amount or volume of components being enclosed or housed within the compartment. In exemplary embodiments, the compartments may contain a breathable aperture (not shown) for venting air from the compartment. During transport, it may be beneficial to remove incidental air that has made its way into the compartment. Accordingly, the compartments (and thus, the sealed container) may include apertures to enable venting of air.

The removable divider 14 provides separation and isolation between the compartments during storage and transport of the repair kit. The removable divider helps to avoid accidental combining of the components present in the compartments. FIG. 2 shows the removable divider 14 disengaged or removed from the sealed container 10. When the removable divider 14 is removed, the first compartment 16 and the second compartment 18 are no longer present. Thus, the sealed container 10 has a single, interior compartment wherein the components can be combined and mixed.

After the removable divider 14 is disengaged, the components previously separated by the divider may be combined within the sealed container 10. For example, the components may be mixed. Hand mixing of the components may be performed by shaking, tilting, turning, or moving the sealed container 10 for a time sufficient to form a significantly or completely homogenous polymeric composite material. The components may also be hand mixed by manipulating or squeezing the sealed container 10 for a time sufficient to form a significantly or completely homogenous polymeric composite material. Sufficient mixing can be performed by hand without the use of a mechanical apparatus that requires electrical power.

In one example, the time sufficient to form a significantly or completely homogenous mixture may be about 180 seconds, 120 seconds, 90 seconds, and/or 60 seconds. The amount of hand mixing required may depend upon one or more of the physical and/or chemical characteristics of the components. In some examples, the time sufficient to form a significantly or completely homogenous mixture of the components is over a range of about 15 seconds to about 300 seconds, preferably over a range of about 30 seconds to about 240 seconds, more preferably over a range of about 30 seconds to about 120 seconds. In some examples, the time sufficient to form a significantly or completely homogenous mixture of the components is for at least about 15 seconds, at least about 30 seconds, at least about 45 seconds, at least about 60 seconds, at least about 75 seconds, at least about 90 seconds, at least about 105 seconds, at least about 120 seconds, at least about 150 seconds, at least about 180 seconds, at least about 210 seconds, at least about 240 seconds, or at least about 270 seconds. In some examples, the time sufficient to form a significantly or completely homogenous mixture of the components is at most about 300 seconds, at most about 270 seconds, at most about 240 seconds, at most about 210 seconds, at most about 180 seconds, at most about 150 seconds, at most about 120 seconds, at most about 105 seconds, at most about 90 seconds, at most about 75 seconds, at most about 60 seconds, at most about 45 seconds, or at most about 30 seconds.

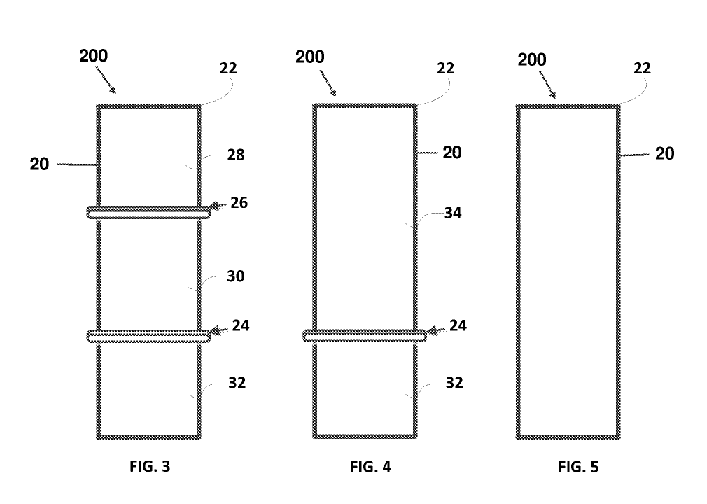

FIG. 3 shows a repair kit 200 comprising a sealed container 20 with a first removable divider 24 and second removable divider 26. As shown, sealed container 20 includes exterior surface 22.

The first removable divider 24 and the second removable divider 26 are disposed transversely across the sealed container 20 from one side thereof to the side directly opposite. In the exemplary embodiment shown in FIG. 3, the first removable divider 24 and the second removable divider 26 are parallel to each other. The first removable divider 24 and the second removable divider 26 form and create three compartments within sealed container 20—a first compartment 28, a second compartment 30, and a third compartment 32. The first compartment 28 comprises the space between exterior surface 22 and removable divider 26. The third compartment 32 comprises the space between exterior surface 22 and removable divider 24. The second compartment 30 comprises the space between removable divider 24 and removable divider 26. Thus, the second compartment 30 is located between the first compartment 28 and the second compartment 32. The size of first compartment 28, second compartment 30, and third compartment 32 may depend on one or more of the amount, the volume, and the ratio of components.

FIG. 4 shows removable divider 26 removed from the sealed container 20, thereby leaving two compartments 32, 34 rather than the three compartments that were present when the removable divider 26 was engaged with the sealed container. Once removable divider 26 is disengaged, the components that were present in compartments 28 and 30 can be combined and mixed in compartment 34.

After the components in compartment 34 are mixed, removable divider 24 may be disengaged from the sealed container 20. FIG. 5 shows the sealed container 20 with both removable divider 24 and removable divider 26 disengaged. When removable divider 24 and removable divider 26 are removed, compartment 34 and compartment 32 are no longer present and the sealed container 20 has a single interior compartment wherein all of the components can be combined and mixed in compartment.

Components

The repair kit comprises components that, when mixed, react to form a polymeric composite material that can be used to repair damaged surfaces. The components that react to form the polymeric composite material are a resin component and reactive component. The resin component and the reactive component may be in the form of a liquid, solid, or a combination thereof. The repair kit comprises components that, when mixed, react to form a polymeric composite material that can be used to repair damaged surfaces. The components that react to form the polymeric composite material are a resin component and reactive component. The resin component and the reactive component may be in the form of a liquid, solid, or a combination thereof. The repair kit can also include a catalyst to accelerate the reaction between the resin and the reactive component. The catalyst may also be in the form of liquid or solid. The filler will typically be in the form of a solid.

Different types of resin components may be used to form the polymeric composite material. For example, an epoxy resin or a polyol resin may be used. If a polyol resin is used, the reactive component that reacts with the resin may be an isocyanate containing compound, and the resulting polymeric composite material is a polyurethane. Alternatively, if an epoxy resin is used, the reactive component that reacts with the resin may be a hardener, such as a polyamine or polyamide, and the resulting polymeric composite material is an epoxy.

The components may be present in the repair kit in amounts that allow a complete reaction between the resin component and the reactive component. Thus, the ratio of the resin component to the reactive component may be determined based on the specific components present in the repair kit. Moreover, the amount of catalyst present in the repair kit may also be dependent on the amount and choice for reactive component and resin component. The filler amount may be affected by various factors including type of filler and intended service use.

Resin Component

As stated above, different resins can be used to form different types of polymeric composite materials. The resin may be an epoxy resin, a polyol resin, a polyurea resin, or a combination thereof. A polyol resin may include a polyol with a hydroxyl-terminated backbone of a member selected from the group consisting of polyether, polyester, polycarbon, polydiene, and polycaprolactone. The polyol resin may include a polyol selected from the group consisting of a hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. The polyol resin may also include adipic acid-ethylene glycol polyester, polybutylene glycol, polypropylene glycol or hydroxyl-terminated polybutadiene. In an exemplary embodiment, the resin is preferably polypropylene glycol. The aforementioned list of polyols is representative of the resins that may be used. However, the polyol suitable for use is not particularly restricted. U.S. Pat. No. 6,635,737, hereby incorporated by reference in its entirety, provides additional polyols that may be used.

The resin may also be a polyurea resin that includes compounds with hydrogen bonded to nitrogen. The polyurea resin may include a polyamine, a polyamide, a polyimine, a polyolamine, or a combination thereof.

The resin may be an epoxy resin comprising a low molecular weight pre-polymer or higher molecular weight polymers containing at least two epoxide groups. The epoxy resin may include diglycidyl ethers of bisphenol A, diglycidyl ethers of bisphenol F, epoxidised novolacs, aliphatic epoxy resins, and glycidylamine epoxy resins.

The resin may have a density in the range of about 5 lbs./gallon to about 13 lbs./gallon, preferably in a range of about 8 lbs./gallon to about 10 lbs./gallon. In some examples, the resin has a density of at least about 5 lbs./gallon, at least about 6 lbs./gallon, at least about 7 lbs./gallon, at least about 8 lbs./gallon, at least about 9 lbs./gallon, at least about 10 lbs./gallon, at least about 11 lbs./gallon, at least about 12 lbs./gallon, or at least about 13 lbs. gallon. In some examples, the resin has a density of at most about 13 lbs./gallon, at most about 12 lbs./gallon, at most about 11 lbs./gallon, at most about 10 lbs./gallon, at most about 9lbs./gallon, at most about 8 lbs./gallon, at most about 7 lbs./gallon, at most about 6 lbs./gallon, or at most about 5 lbs./gallon. Preferably, the resin has a density of about 9 lbs./gallon.

The resin may be stored separately in the repair kit in its own compartment or it may be combined with one or more other components in a compartment for storage prior to use of the repair kit. For example, it may be stored in combination with the catalyst.

Reactive Component

As indicated above, the reactive component in a repair kit may be dependent on the type of resin present in the repair kit. For example, an isocyanate containing compound can be reacted with a polyol resin to form a polyurethane composite material. The isocyanate containing compound should have at least one isocyanate functional group. The functional group may be an aliphatic isocyanate, a cycloaliphatic isocyanate, an aryl isocyanate, an aromatic cyanate, or a combination thereof. The functional group may be 1,6-hexamethylene diisocyanate, 1,4-butylene diisocyanate, furfurylidene diisocyanate, 2,4-toluene diisocyanate, 2,6-toluene diisocyanate, 2,4′-diphenylethane, diisocyanate, 4,4′ -diphenylmethane diisocyanate, 4,4′-diphenylpropane diisocyanate, 4,4′ -diphenyl-3,3′-dimethyl methane diisocyanate, 1,5-naphthalene diisocyanate, 1-methyl-2,4-diisocyanate-5-chlorobenze, 2,4-diisocyanate-s-triazine, 1-methyl-2,4-diisocyanato cyclohexane, p-phenylene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates or a combination thereof. In an exemplary embodiment, the preferred isocyanate functional group may be polymethylene polyphenyl polyisocyanates. The aforementioned list of isocyanate functional groups is representative of the isocyanate functional groups that may be used. However, the isocyanate functional groups suitable for use are not particularly restricted. U.S. Pat. No. 5,422,385, hereby incorporated by reference in its entirety, provides additional isocyanates that may be used.

In an exemplary embodiment wherein the resin component is an epoxy resin, the reactive component may be a hardener or a curative. The reaction between the epoxy resin and the hardener may also be referred to as curing. Exemplary hardeners include polyfunctional amines, acids (and acid anhydrides), phenols, alcohols and thiols.

The reactive component may have a density in the range of about 5 lbs./gallon to about 13 lbs./gallon, preferably in a range of about 8 lbs./gallon to about 10 lbs./gallon. In some examples, the reactive component may have a density of at least about 5 lbs./gallon, at least about 6 lbs./gallon, at least about 7 lbs./gallon, at least about 8 lbs./gallon, at least about 9 lbs./gallon, at least about 10 lbs./gallon, at least about 11 lbs./gallon, at least about 12 lbs./gallon, or at least about 13 lbs. gallon. In some examples, the reactive component has a density of at most about 13 lbs./gallon, at most about 12 lbs./gallon, at most about 11 lbs./gallon, at most about 10 lbs./gallon, at most about 9lbs./gallon, at most about 8 lbs./gallon, at most about 7 lbs./gallon, at most about 6 lbs./gallon, or at most about 5 lbs./gallon. In an exemplary embodiment, the reactive component may preferably have a density of about 9 lbs./gallon.

The reactive component may be stored separately in the repair kit in its own compartment or it may be combined with one or more other components in a compartment for storage prior to use of the repair kit. For example, it may be stored in combination with the filler.

Catalyst

The repair kit may include a catalyst to accelerate the reaction between the resin and the reactive component. The catalyst may include amine compounds and metal-based compounds. Exemplary metal compounds may be based on tin, mercury, lead, bismuth, and zinc. Exemplary amine compounds may include tertiary amines such as triethylenediamine (TEDA), dimethylcyclohexylamine (DMCHA), and dimethylethanolamine (DMEA). The catalyst may be stored separately in the repair kit in its own compartment or it may be combined with one or more other components in a compartment for storage prior to use of the repair kit. For example, it may be stored in combination with the resin or with the filler.

Filler

A filler may also be included as a component in the repair kit. Exemplary fillers include glass, sand, rock, rubber crumb, architectural stone, low density fillers such as polystyrene beads (expanded or unexpanded) or expanded glass beads, or combinations thereof. In exemplary embodiments, the filler may be glass beads, for example, recycled glass beads. Other types of glass may also be suitable for use as a filler. The glass may be of any type and may be clear, tinted, and/or colored. For example, the glass may be post-consumer waste recycled glass such that economic and environmental costs are minimized

The filler may have a density in a range of about 7 lbs./gallon to about 15 lbs./gallon, preferably in a range of about 10 lbs./gallon to about 12 lbs./gallon. In examples, the filler may have a density of at least about 7 lbs./gallon, at least about 8 lbs./gallon, at least about 9 lbs./gallon, at least about 10 lbs./gallon, at least about 11 lbs./gallon, at least about 12 lbs./gallon, at least about 13 lbs./gallon, at least about 14 lbs./gallon, or at least about 15 lbs./gallon. In other examples, the filler may have a density in a range of at most about 15 lbs./gallon, at most about 14 lbs./gallon, at most about 13 lbs./gallon, at most about 12 lbs./gallon, at most about 11 lbs./gallon, at most 10 lbs./gallon, at most about 10 lbs./gallon, at most about 9 lbs./gallon, at most about 8 lbs./gallon, or at most about 7 lbs./gallon. In an exemplary embodiment, the filler may have a density of about 11 lbs./gallon. Low density fillers may also be used in the repair kit. A low density filler may have a density in the range of about 15 to 55 lb./ft³. The size of the low density fillers may vary between 0.02 mm-10 mm.

As discussed above, the density of the filler may be relatively similar to that of the resin and the reactive component. For example, the density of the filler may be within about 4 lbs., gallon, about 3 lbs./gallon, about 2.5 lbs./gallon, about 2 lbs./gallon, about 1.5 lbs./gallon, about 1.0 lbs./gallon, or about 0.5 lbs./gallon of the densities of the reactive component and the resin. When the density of the filler is relatively similar to that of the resin and the reactive components, the filler is less likely to crash out of the suspension that is formed when the resin, the reactive component, and the filler are mixed. Thus, the density similarity aids in enabling the components of the repair kit to be mixed without the use of a mechanical apparatus. Rather, the components can be mixed by hand.

The filler may be stored separately in the repair kit in its own compartment or it may be combined with one or more other components in a compartment for storage prior to use of the repair kit. For example, it may be stored in combination with the reactive component or the resin component.

Methods for Preparing a Polymeric Composite Material and for Repairing Surfaces

The method for making a composite for repairing a surface includes providing a repair kit comprising a sealed container having a resin component and a reactive component enclosed therein. As discussed previously, the repair kit includes a first removable divider arranged transversely across the sealed container to form a compartment for enclosing the resin component and a compartment for enclosing the reactive component. The first removable divider can be removed or disengaged from the sealed container to allow the resin component to combine and be mixed with the reactive component in the sealed container thereby enabling a reaction between the resin component and the reactive component. Once the first removable divider is removed, the components that were present in the first compartment and the second compartment (e.g., resin component, reactive component, and optionally catalyst and/or filler) can be combined and mixed in the sealed container. The components can be conveniently hand mixed within the sealed container to form a polymeric composite material. Advantageously, hand mixing can be accomplished without mechanical equipment that requires electrical power.

If the repair kit includes a second removable divider that forms a third compartment in the sealed container, the second removable divider can be removed after the contents of the first compartment and the second compartment are mixed. For example, a reactive component and a filler may be present in the first compartment and the second compartment, respectively, and a resin component, and optionally a catalyst, may be present in the third compartment.

In this exemplary embodiment, when the first removable divider is removed, the reactive component and the filler may be combined and mixed using hand mixing. Then the second removable divider can be removed and the combined reactive component and filler can be combined and mixed with the resin component using hand mixing such that the resin component and the reactive component can react to form the polymeric composite material. A catalyst may be present in one of the first compartment, the second compartment, or the third compartment for accelerating the reaction between the resin component and the reactive component.

The amount of hand mixing required may depend upon one or more of the physical and/or chemical characteristics of the reactive component, the filler, or the resin component. Hand mixing the resin component, the reactive component, the filler, and the catalyst, in the various combinations, is performed without a mechanical apparatus. For example, hand mixing can be performed by shaking, tilting, turning, or moving the sealed container from side to side for a time sufficient to form a significantly or completely homogenous component mixture. Such component mixture may include any two or more of the available components. In another example, hand mixing can be performed by manipulating or squeezing the sealed container or a subset of compartments of the sealed container, from one end to the other for a time sufficient to form a significantly or completely homogenous component mixture. In one example, the time sufficient to form a significantly or completely homogenous component mixture can be about 180 seconds, about 120 seconds, or about 60 seconds, depending on the components being mixed. It will be appreciated that the time for mixing different combinations of components may vary. For example, completely mixing the filler and the reactive component may a different amount of time than homogenously mixing the reactive component and the resin component.

The method also includes a step of applying the polymeric composite material to an aged or damaged portion of a surface after it has been prepared. The aged or damaged portion may be a pothole, divot, crack, groove, compression, rut, or the like. The surface may be an asphalt layer or concrete layer. The surface may also be part of a component of a building, a concrete form, a road, a railway infrastructure, or the like.

In order to apply the polymeric composite material, the sealed container will be opened to remove the composite material therefrom. To that end, the sealed container may include a sealed opening (not shown in FIGS. 1-9) that may be unsealed after the composite is produced. Alternatively, the sealed container may be punctured or cut open to allow the polymeric composite material to be applied to the aged or damaged portion of the surface. After the composite material is applied to the aged or damaged portion of the surface, the composite may be screeded and troweled. Once the composite has fully cured, the fixed surface is ready for use.

Preferably, the method of making the composite for repairing the surface does not require external heat. For example, the method may be performed at room temperature.

### EXAMPLES

A repair kit including a three compartment sealed container was used to prepare a polymeric composite material. In this example, the sealed container was a Mylar® pouch and the removable dividers were clips. The reactive component was in one compartment, the resin component was in a second compartment, and a filler was in a third compartment. The reactive component was an isocyanate containing compound in liquid form, specifically a blend of aromatic diphenylmethane diisocyanate compounds. The resin component was a blend of hydroxyl-terminated compounds (polyols) and was also in liquid form, and the filler was recycled glass beads. Table 1 below provides the amount and density of the reactive component, the resin component, and the filler. As can be seen, the reactive component had a density about 9.5 lbs/gallon, the resin component had a density around 9 lbs./gallon, and the filler had a density around 11 lbs./gallon. Thus, the densities of the three components were relatively similar. The components were mixed to produce an aromatic polyurethane.

TABLE 1

| Two Divider | Unit | | |
|---|---|---|---|
| Example: Resin: Filler: Reactive component | Qty | UOM | WPG |
| Reactive component: ISO | 1.23 | LB | 9.48 |
| Resin component: Resin | 1.10 | LB | 8.86 |
| Filler: Aggregate, recycled glass beads | 4.75 | LB | 11.2 |

When preparing the polyurethane, the clip separating the compartment containing the isocyanate containing compound and the compartment containing the recycled glass beads was removed. The clip separating the resin component initially remained in place. The isocyanate containing compound and the glass beads were combined and mixed using hand mixing for a time period of about 60 seconds. Hand mixing may include manipulation of the sealed container by squeezing, massaging, shaking or moving it in various directions such as up and down, side to side or turning it around in a rotating motion. Once a substantially homogenous mixture of isocyanate containing compound and glass beads was prepared, the second clip was removed. Then, the resin component was combined and mixed with the previously combined isocyanate containing compound and glass beads using hand mixing. The components were mixed for approximately 60 seconds. The resin and the isocyanate containing compound reacted to form a polyurethane with the glass beads suspended therein.

In a second exemplary method, a second repair kit including a two compartment sealed container was used to prepare a polymeric composite material. In this example, the sealed container was a Mylar® pouch and the removable divider was a clip. The reactive component was in the first compartment, and the resin component and filler were in the second compartment. The reactive component was an isocyanate containing compound in liquid form, specifically a blend of aromatic diphenylmethane diisocyanate compounds. The resin component was a blend of hydroxyl-terminated compounds (polyols) and was also in liquid form, and the filler was recycled glass beads. Table 2 below provides the amount and density of the reactive component, the resin component, and the filler. As can be seen, the reactive component had a density about 9.5 lbs/gallon, the resin component had a density around 9 lbs./gallon, and the filler had a density around 11 lbs./gallon. Thus, the densities of the three components were relatively similar. The components were mixed to produce an aromatic polyurethane.

TABLE 2

| One Divider | Unit | | |
|---|---|---|---|
| Example. Resin/Aggregate: Reactive component | Qty | UOM | WPG |
| Reactive component: ISO | 1.23 | LB | 9.48 |
| Resin component: Resin | 1.10 | LB | 8.86 |
| Filler: Aggregate, recycled glass beads | 4.75 | LB | 11.2 |

When preparing the polyurethane, the clip separating the compartment containing the isocyanate containing compound and the recycled glass beads from the compartment containing the resin component was removed. The isocyanate containing compound and the glass beads were combined and mixed with the resin component using hand mixing until a substantially homogenously polymeric composite material was formed. The time for mixing was about 60 seconds. The resin and the isocyanate containing compound reacted to form a polyurethane with the glass beads suspended therein.

Many modifications and other embodiments of the present disclosure will come to mind to one skilled in the art to which the present disclosure pertains having the benefit of the teachings presented in the foregoing description; and it will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A repair kit comprising:
a sealed container; and
a first removable divider arranged transversely across the sealed container, said divider configured to engage the sealed container to form a first compartment and a second compartment, which first compartment and second compartment are isolated from one another when the first removable divider is engaged with the sealed container;
wherein the first compartment contains a resin component and the second compartment contains a reactive component, and
wherein the sealed container is configured such that removal of the first removable divider enables mixing of the resin component and the reactive component within the sealed container.

2. The repair kit of claim 1, further comprising a second removable divider arranged transversely across the sealed container, said divider configured to engage the sealed container to form a third compartment, which third compartment is isolated from the first compartment and the second compartment when the second removable divider and the first removable divider are engaged with the sealed container, wherein the third compartment contains a third component, which is different from the resin component and the reactive component and wherein the sealed container is configured such that the contents of the first compartment, the second compartment, and the third compartment can be combined when the first removable divider and the second removable divider are disengaged, enabling mixing of the resin component, the reactive component, and the third component within the sealed container.

3. The repair kit of claim 2, wherein the resin component comprises a resin.

4. The repair kit of claim 3, wherein the reactive component comprises an isocyanate containing compound or an epoxy hardener and the third component comprises a filler.

5. The repair kit of claim 3, wherein the resin is selected from the group consisting of an epoxy resin, a polyol resin, a polyurethane forming resin, a polyurea resin and combinations thereof.

6. The repair kit of claim 5, wherein the polyol resin is selected from the group consisting of a polyol with a hydroxyl-terminated backbone of a member selected from the group consisting of polyether, polyester, polycarbon, polydiene, and polycaprolactone; hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols, polyalkyleneether triols, adipic acid-ethylene glycol polyester, polybutylene glycol, polypropylene glycol, hydroxyl-terminated polybutadiene and combinations thereof.

7. The repair kit of claim 1, wherein the resin component comprises polypropylene glycol.

8. The repair kit of claim 4, wherein the isocyanate containing compound is selected from the group consisting of aliphatic isocyanates, cycloaliphatic isocyanates, aryl isocyanates, aromatic cyanates, and combinations thereof.

9. The repair kit of claim 8, wherein the isocyanate containing compound is selected from the group consisting of 1,6-hexamethylene diisocyanate, 1,4-butylene diisocyanate, furfurylidene diisocyanate, 2,4-toluene diisocyanate, 2,6-toluene diisocyanate, 2,4′-diphenylethane, diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenze, 2,4-diisocyanate-s-triazine, 1-methyl-2,4-diisocyanato cyclohexane, p-phenylene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and combinations thereof.

10. The repair kit of claim 1, further comprising a catalyst, wherein the catalyst comprises tin, mercury, lead, bismuth, zinc or various amine compounds.

11. The repair kit of claim 4, wherein the filler is selected from the group consisting of rock, glass, rubber crumb, sand, architectural stone, polystyrene and combinations thereof.

12. The repair kit of claim 11, wherein the filler comprises glass.

13. The repair kit of claim 12, wherein the glass is recycled glass.

14. The repair kit of claim 1, wherein densities of the reactive component and the resin component are substantially similar.

15. The repair kit of claim 14, further comprising a filler, wherein a density of the filler is approximately 2 lbs./gallon greater than the densities of the reactive component and the resin component.

16. The repair kit of claim 4, wherein densities of the reactive component, the resin component, and the filler are substantially similar.

17. The repair kit of claim 2, wherein any of the removable dividers comprise a snap, clip, insert, or a combination thereof.

18. A method for preparing a composite material for repairing a surface, the method comprising:
providing a repair kit comprising a sealed container having at least a resin component and a reactive component enclosed therein and a first removable divider configured to engage the sealed container to isolate the resin component from the reactive component;
disengaging the first removable divider from the sealed container, wherein disengaging the first removable divider allows the resin component to be combined with the reactive component in the sealed container; and
mixing the resin component and the reactive component in the sealed container to form the composite material.

19. The method of claim 18, further comprising:
providing a second removable divider for the repair kit, wherein the second removable divider is configured to engage the sealed container to form a third compartment enclosing a third component;
removing the second removable divider and the first removable divider from the sealed container, wherein removing the second removable divider and the first removable divider allows the reactive component, the resin component, and the third component to be combined in the sealed container; and
mixing the reactive component, the resin component, and the third component in the sealed container to form the composite material.

20. The method of claim 19, wherein mixing the combined components is performed without a mechanical apparatus.
